(19) United States
(12) Patent Application Publication
(10) Pub. No.: US 2009/0317017 A1
(43) Pub. Date: Dec. 24, 2009

(54) IMAGE CHARACTERISTIC ORIENTED TONE MAPPING FOR HIGH DYNAMIC RANGE IMAGES

(75) Inventors: Oscar Chi Lim Au, Hong Kong (CN); Chun Hung Liu, Hong Kong (CN)

Correspondence Address: TUROCY & WATSON, LLP, 127 Public Square, 57th Floor, Key Tower, CLEVELAND, OH, 44114, US

(73) Assignee: The Hong Kong University of Science and Technology, Hong Kong (CN)

(21) Appl. No.: 12/142,946

(22) Filed: Jun. 20, 2008

(51) Int. Cl. G06K 9/40

(52) U.S. Cl. 382/274

(57) ABSTRACT

A method and system map high dynamic range images to low dynamic range images. An input set of luminance values can be divided into separate regions corresponding to particular luminance value ranges. A region value can be determined for each region. Based at least in part on the region value, a quantity of range assigned to each region for tone mapping can be dynamically adjusted until each region meets a decision criterion or stopping condition, referred to herein as “concentration.” A region can be said to be concentrated if all luminance values therein are within a concentration interval or range. After a region is concentrated, it can be tone-mapped by quantization.

### TECHNICAL FIELD

The subject disclosure relates to image processing techniques including one or more aspects of image characteristic oriented tone mapping for high dynamic range images.

### BACKGROUND

In real-world settings, the range of light can be vast. For example, the luminance ratio between starlight and sunlight may be greater than ten orders.

Notwithstanding, common cameras may only enable capturing 8-bit, 256-luminance-level photographs. If such a camera captures a scene with high contrast, for example a scene including indoor and outdoor environment, the captured image will likely be underexposed or overexposed in some regions.

Ways are known of addressing the above-described problem. For example, with the help of high dynamic range (HDR) cameras and some existing HDR imaging methods, HDR images with improved quality can be generated. However, generating a suitable display or print of the improved image presents further problems. For example, common liquid crystal displays (LCDs) are of only 8-bit contrast ratio, and printers have an even lower contrast ratio. Consequently, such devices are typically inadequate for showing the full quality of HDR images.

One way to generate a high-quality HDR display is to buy high-quality HDR display equipment. However, such equipment is usually very expensive.

Lower-cost solutions include tone mapping. Tone mapping is a process to convert the tonal values of an image with a high dynamic range to a lower one. Thus, tone mapping may be used to convert an HDR image to a low dynamic range (LDR) image visually suitable for common display monitors.

Tone mapping has been researched for a period of time. There are two main categories: tone reproduction operator (TRO)-based; and tone reproduction curve (TRC)-based. The main difference between TRO-based techniques and TRC-based techniques is that TRC-based mapping uses a global operator, while TRO-based mapping uses a local one.

More specifically, TRC-based mapping provides a reproduction curve for mapping HDR data to lower range values globally without any spatial processing. An advantage of TRC is that it can provide a tone-mapped image with the original characteristics of the HDR image. The brighter part of the image will be mapped to greater values and the dimmer part will be mapped to smaller values. However, local contrast may be lost due to the compression of the dynamic range. One conventional TRC technique calculates the real world radiance values of a scene instead of the display radiance values that will represent them.

In contrast to TRC-based mapping, TRO-based mapping focuses on local details. It generates a tone-mapped image that preserves or even enhances the local contrast. Generally, TRO-based mapping provides more details in the tone-mapped image, but too many details can make the image look artificial. The loss of global contrast results makes it difficult to distinguish which part of the image is originally bright and which part is originally dim. Another disadvantage is that TRO-based mapping is computationally expensive, as it involves the spatial manipulation of local neighboring pixels. Conventional TRO-based techniques attempt to separate the luminance component from the reflectance component in the image formation model. Other conventional systems provide a tonal reproduction curve while at the same time considering the human visual system.

As stated previously, TRC-based methods can retain the whole image's characteristics. However, the difference between the maximum and minimum values of common HDR images is extremely large and most of the time, the population deflects to one side as discussed further on with respect to FIG. 2. Therefore, in the first step of many tone-mapping techniques, the logarithm of the luminance layer is taken, or the luminance layer is otherwise mapped, to compress the range between the extreme values. But consequently, the shape of the histogram will have changed (especially the population of the brighter part is greatly compressed) and the mapping values are no longer linear with respect to the original luminance values.

In view of the above, there is a need for tone mapping capable of reproducing the appearance of an HDR image on common display devices in an efficient and inexpensive manner, and that avoids the above-described deficiencies of current designs for tone mapping.

The above-described deficiencies are merely intended to provide an overview of some of the problems of today's designs, and are not intended to be exhaustive. For instance, other problems with the state of the art may become further apparent upon review of the following description of various non-limiting embodiments below.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

In various non-limiting embodiments, high dynamic range images are mapped to low dynamic range images. An input set of luminance values can be divided into separate regions corresponding to particular luminance value ranges. A region value can be determined for each region. Based at least in part on the region value, a quantity of range assigned to each region for tone mapping can be dynamically adjusted until each region meets a decision criterion or stopping condition, referred to herein as “concentration.” A region can be said to be concentrated if all luminance values therein are within a concentration interval or range. After a region is concentrated, it can be tone-mapped by quantization.

In view of the above, it can be seen that in embodiments of the invention, a logarithmic process or adaptive mapping to compress the range of the image as a first step, as in the current designs discussed above, are avoided. This prevents the undesirable side effects of current designs, discussed above, of distorting the shape of the histogram and the original image's characteristics.

To the accomplishment of the foregoing and related ends, certain illustrative aspects of the claimed subject matter are described herein in connection with the following description and the annexed drawings. These aspects are indicative, however, of but a few of the various ways in which the principles of the claimed subject matter can be employed. The claimed subject matter is intended to include all such aspects and their equivalents. Other advantages and novel features of the claimed subject matter can become apparent from the following detailed description when considered in conjunction with the drawings.

### BRIEF DESCRIPTION OF THE DRAWINGS

Various non-limiting embodiments are further described with reference to the accompanying drawings in which:

FIG. 1 shows a high-level process flow according to embodiments of the present invention;

FIG. 2 shows an example of a histogram of an HDR image;

FIG. 3 shows an example of a histogram of the same HDR image, focusing on the low luminance values;

FIG. 4 shows a process flow for forming and applying a decision criterion for tone mapping;

FIG. 5 shows a process flow for determining a concentration interval or range related to the decision criterion;

FIG. 6 shows dividing a region of luminance values into plural separate regions;

FIG. 7 shows further dividing the regions according to a recursive iteration;

FIG. 8 shows a process flow for dynamic range allocation for the regions;

FIG. 9 shows tone mapping of concentrated regions;

FIG. 10 shows a process flow further detailing the tone mapping;

FIG. 11 shows a histogram of a related art tone mapped image with respect to the HDR histogram as in FIGS. 2 and 3;

FIG. 12 shows a histogram of the tone mapped image when processed using components according to embodiments of the invention, with respect to the HDR histogram as in FIGS. 2 and 3;

FIG. 13 shows an image processing system to implement components according to embodiments of the invention;

FIG. 14 shows further details of the image processing system;

FIG. 15 shows an example of one possible configuration including an image capture device and a computer system for implementing embodiments of the invention;

FIG. 16 shows an example of another possible configuration including mobile devices and a network for implementing embodiments of the invention; and

FIG. 17 shows still another example of a possible configuration including a set-top box and a television for implementing embodiments of the invention.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process and/or thread of execution and a component may be localized on one computer and/or distributed across two or more computers. Also, the methods and apparatus of the claimed subject matter, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the claimed subject matter. The components may communicate via local and/or remote processes such as in accordance with a signal having one or more data packets (e.g., data from one component interacting with another component in a local system, distributed system, and/or across a network such as the Internet with other systems via the signal).

Furthermore, the claimed subject matter may be described in the general context of computer-executable instructions, such as program modules, executed by one or more components. Generally, program modules include routines, programs, objects, data structures, etc., that perform particular tasks or implement particular abstract data types. Typically the functionality of the program modules may be combined or distributed as desired in various embodiments. Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers, . . . ). Such components, inter alia, can automate certain mechanisms or processes performed thereby to make portions of the systems and methods more adaptive as well as efficient and intelligent.

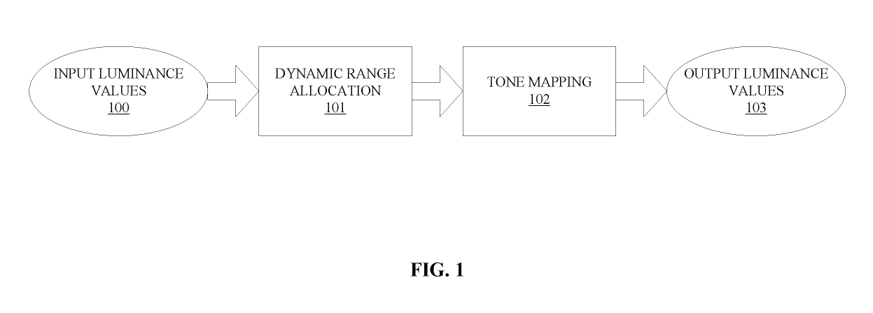

In various non-limiting embodiments of the invention, an image can be processed to improve a corresponding display or print of the image. Referring now to FIG. 1, the image can comprise digital information representing an input set of luminance values 100 (also referred to herein as a “population”). Operations according to embodiments of the invention can apply dynamic range allocation 101 to the input luminance values 100, followed by tone mapping 102. The dynamic range allocation 101 and tone mapping 102 components can generate an output set of luminance values 103 with improved display qualities. In particular, the input set of luminance values 100 can correspond to an HDR image, and the output set of luminance values 103 can be suitable for generating a display or print for viewing or printing on an LDR device.

According to various non-limiting embodiments, operations of the dynamic range allocation 101 component can include dividing the input set of luminance values 100 into separate regions corresponding to particular luminance value ranges. A region value can be determined for each region.

Based at least in part on the region value, a quantity of range assigned to each region for tone mapping can be dynamically adjusted until each region meets a decision criterion or stopping condition, referred to herein as “concentration.” A region can be said to be concentrated if all luminance values therein are within a concentration interval or range. The concentration interval or range can be determined based on characteristics of luminance values in a corresponding region.

After a region is concentrated, operations of the tone mapping component 102 can include tone-mapping the concentrated region by quantization.

After quantization, adaptive techniques can be applied to the resulting tone-mapped images to adjust brightness or dimness.

### 1. ILLUSTRATIVE EXAMPLE

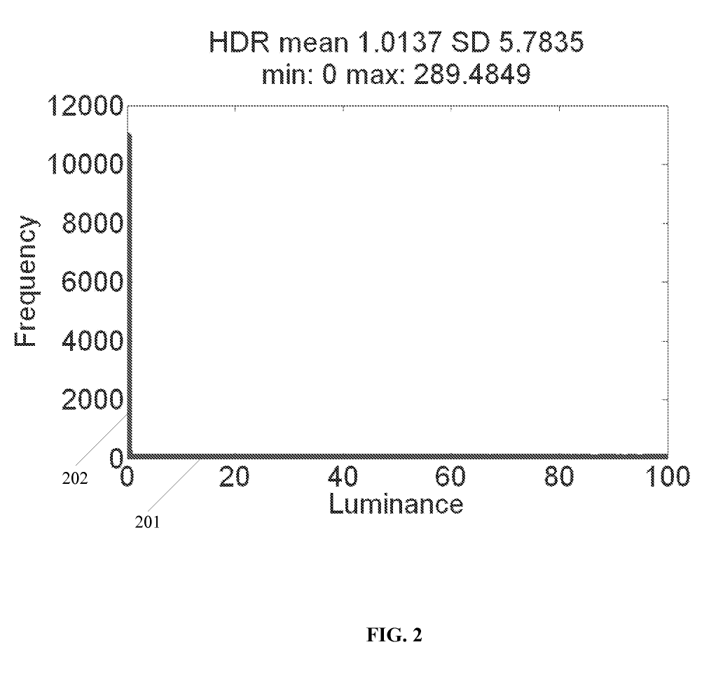

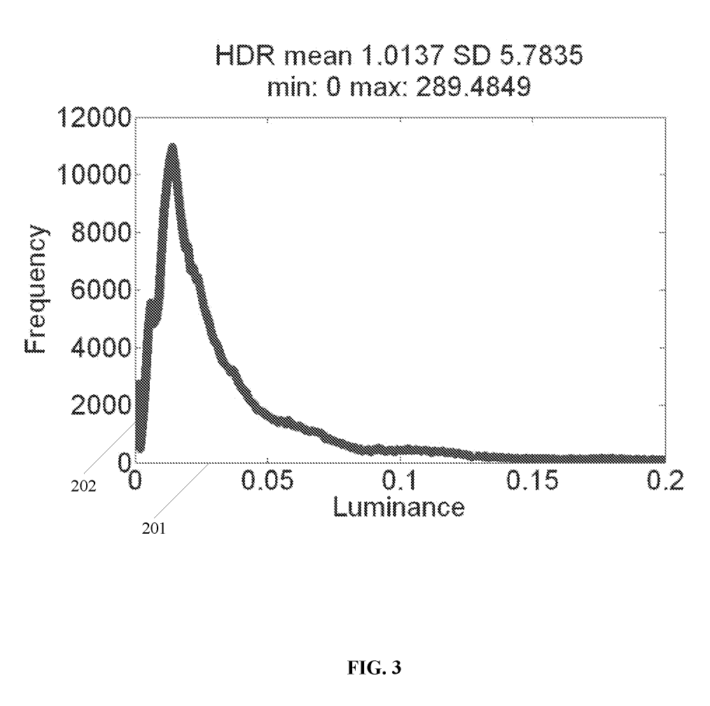

FIGS. 2 and 3 illustrate, by way of example, concepts applied in various non-limiting embodiments of the invention. FIG. 2 shows a histogram for HDR data, with a luminance value axis 201 and a frequency axis 202. Solely by way of non-limiting illustrative example, the luminance data of the histogram has a mean of 1.0137, a standard deviation of 5.7835, a minimum value of 0, and a maximum value of 289.4849. FIG. 3 shows the same histogram and only focuses on the low luminance values.

If 3 bits are used to perform uniform quantization of an HDR image, as can be seen, most of the values are mapped to zero on the luminance axis 201, and consequently almost all details are lost.

By contrast, if the luminance range 201 is first divided into parts, and uniform quantization is separately performed on each part, the result will be improved. For example, if luminance values are divided into a region corresponding to values between 0 and 0.1 on the luminance axis 201, and a region corresponding to values above 0.1 on the luminance axis 201, and uniform quantization is performed separately on each region, the result will be improved. Global contrast is retained and there are certain values to retain local details as well.

### 2. CONCENTRATION

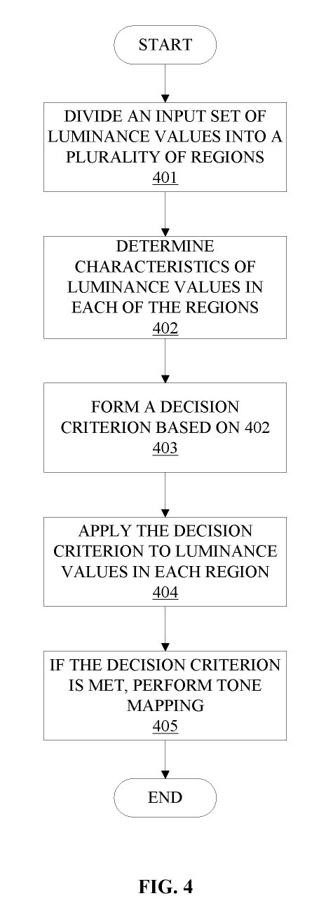

In various non-limiting embodiments of the invention, concepts as illustrated in the above example are applied. Referring now to FIG. 4, in a dynamic range allocation component 101 (see FIG. 1), an input set of luminance values can be divided into a plurality of regions (block 401). Characteristics of the luminance values, such as their minimum, maximum, mean and standard deviation, in a corresponding region, can be determined (block 402). As shown in block 403, a decision criterion or stopping condition can be formed, based on the determination of block 402. The decision criterion or stopping condition can be based on a concentration interval or range determined based on the characteristics of the luminance values. The decision criterion can be applied to the luminance values in each region (block 404), and if the criterion is met, tone-mapping of the luminance values in each region can be performed (block 405).

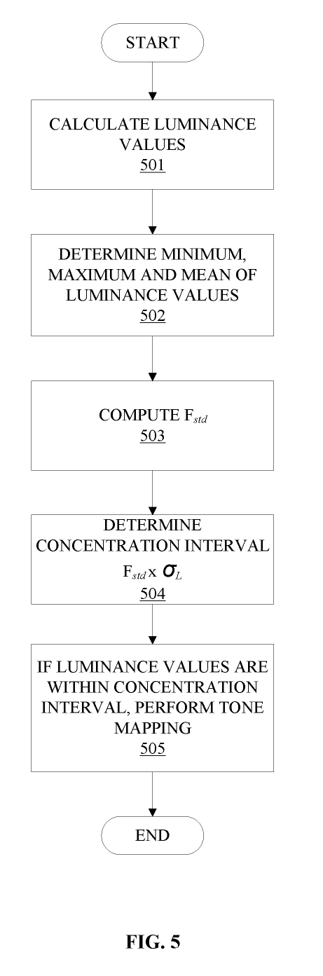

In various non-limiting embodiments, the concentration interval or range can be defined in terms of a factor, referred to herein as F_{std}, multiplied by the standard deviation for a corresponding region. To this end, the dynamic range allocation component 101 can include operations as shown in FIG. 5. Referring now to FIG. 5, input luminance values 100 (see FIG. 1) (L) of an image can be calculated (block 501) according to the following expression:

L=0.299×R+0.587×G+0.114×B (1)

where R, G, and B correspond to red, green and blue, as in RGB pixel coloration. The RGB values can be in the form of digital data stored in a computer memory, for example. The RGB values may, for instance, have been captured by an image capture device, such as a digital camera. An initial population of luminance values (L), referred to herein for convenience as Region L, can be considered as a whole or global region that can be subsequently partitioned into separate regions. The luminance values of Region L can be sorted in ascending order.

The minimum, maximum and mean values of the luminance values can be determined (block 502), and the F_{std} factor can be computed based on the minimum, maximum and mean values (block 503). Specifically, for example, for Region L, factor F_{std} can be computed in terms of the global maximum, minimum and mean luminance values of Region L, denoted respectively as Lmax_{g}, Lmin_{g} and Lmean_{g}, as follows:

Diffₘₘ=min[(Lmean_{g}−Lmin_{g}), (Lmax_{g}−Lmean_{g})] (2)

F_{std}={square root over (log 10(8+(Lmax_{g}−Lmin_{g})/Diffₘₘ))} (3).

F_{std} indicates the degree of the population deflection. To determine the concentration interval or range that serves as a basis for a decision criterion or stopping point as discussed above, the F_{std} value can be multiplied by the standard deviation σ_{L} of Region L (block 504).

To apply the decision criterion, it can be determined whether the luminance values of the population are within the concentration interval or range, defined as ±(F_{std}×σ_{L}). If it is determined that the luminance values are within ±(F_{std}×σ_{L}), Region L is said to be concentrated and is not further divided. Instead, tone-mapping can be performed on the luminance values of Region L (block 505).

### 3. REGIONS

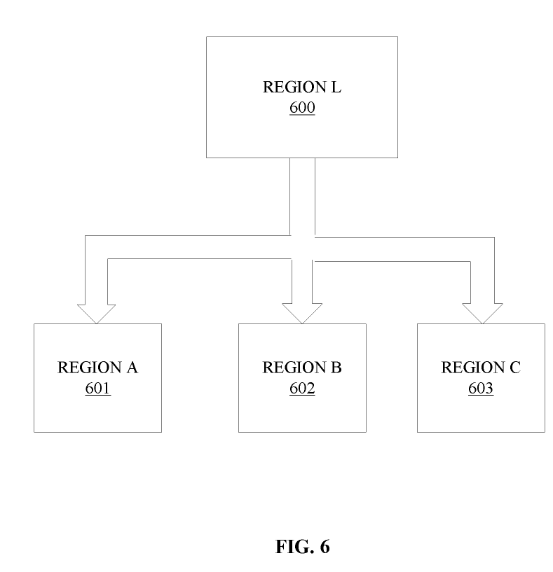

On the other hand, if it is determined that the luminance values are not within ±(F_{std}×σ_{L}), Region L is not concentrated, and consequently can be divided into plural regions. Referring now to FIG. 6, in various non-limiting embodiments, Region L (600) can be divided into three separate regions: (i) a Region A (601) containing a population whose luminance values are smaller than −(F_{std}×σ_{L}); (ii) a Region B (602) containing a population whose luminance values are within ±(F_{std}×σ_{L}); and (iii) a Region C (603) containing a population whose luminance values are greater than (F_{std}×σ_{L}).

Region values Rg_{A}, Rg_{B} and Rg_{C} can be computed for each region. As mentioned previously, the region values can be used to dynamically allocate a reproduction range, subsequently used in tone mapping, for each region. In each region, a probability density, P, and a range, R, can be determined and used in computing the region values. For example, if P=0, the corresponding region value (Rg) will be set to zero, since a region without any population need not be allocated any dynamic range.

For computing Rg, alternative factors F_{P1} or F_{P2} can be calculated using the below expressions:

$$\begin{matrix}{F}_{P 1} = log 10 ( 8 + \frac{L {max}_{L} - L {min}_{L}}{min [ ( {Lmean}_{L} - L {min}_{L} ) , ( L {max}_{L} - {Lmean}_{L} ) ]} ) & ( 4 ) \\ {F}_{P 2} = 0.5 + {( \frac{{Pmean}_{L}^{′}}{2} )}^{{2}^{k}} & ( 5 )\end{matrix}$$

where k is an iteration number and Pmean_{L} is the probability density greater than the mean in Region L. If Pmean_{L}<0.5, Pmean′_{L}=1−Pmean_{L}. Otherwise, Pmean′_{L}=Pmean_{L}.

For Region A, the region value Rg_{A} can be expressed as:

Rg_{A}=P_{A}^{F}^{_{P1}}×R_{A} (6).

Rg_{B} and Rg_{C}, i.e., region values for Region B and Region C, respectively, can likewise be calculated using expressions (4), (5) and (6), replacing P_{A} and R_{A} with P_{B}, R_{B}, P_{C} and R_{C} correspondingly.

### 4. DYNAMIC RANGE ALLOCATION

In embodiments of the invention, after region values have been determined, dynamic range allocation for tone mapping can be performed using the region values. The dynamic range allocation can include plural iterations performed recursively.

On a first iteration or if the whole population (Region L) does not come from Region B of any previous iteration, F_{P1} can be used for calculating the region values as described above. When F_{P1} is used, it means that the population of Region L may deflect to one side, and consequently greater range should be given to that side for quantization. Accordingly, F_{P1} (usually >1) may be used as a power index or exponent of the probability density in (6), which makes Rg relatively larger with higher probability density. Greater deflection results in greater F_{P1}.

Otherwise F_{P2} can be used instead of F_{P1} in (6). When F_{P2} is used, it means that the population of Region L is at least once within a certain standard deviation, which is quite concentrated. If, in such a case, the range allocated were still according to the probability density it would be similar to histogram equalization, which results in loss of contrast. Therefore, in this case, F_{P2} (usually <1) is used as the power index or exponent in (6), which makes Rg depend more on the range so that the local details can be maintained.

As region values are computed, a dynamic range for mapping by quantization can be allocated. DR_{A}, DR_{B} and DR_{C} are the quantity of range allocated to Region A, B and C respectively. In embodiments, DR_{A}, DR_{B} and DR_{C} can be determined using the below expressions:

$$\begin{matrix}{DR}_{A} = round ( DR \times \frac{{Rg}_{A}}{{Rg}_{A} + {Rg}_{B} + {Rg}_{C}} ) & ( 7 ) \\ {DR}_{C} = round ( DR \times \frac{{Rg}_{C}}{{Rg}_{A} + {Rg}_{B} + {Rg}_{C}} ) & ( 8 ) \\ {DR}_{B} = DR - {DR}_{A} - {DR}_{C} . & ( 9 )\end{matrix}$$

If Rg_{A} or Rg_{C} is not equal to 0, DR_{A} or DR_{C} in (7) and (8) will be at least 1 as every luminance value should have a mapping value.

After a first iteration of dynamic range allocation, DR_{A}, DR_{B} and DR_{C} can be applied to redefine the ranges allocated to Regions A, B and C respectively. It can then be determined whether the regions thus obtained are concentrated or have a corresponding DR value (i.e., DR_{A}, DR_{B} or DR_{C})=1. If all the regions are either concentrated or have a corresponding DR value=1, no further dynamic range allocation is performed.

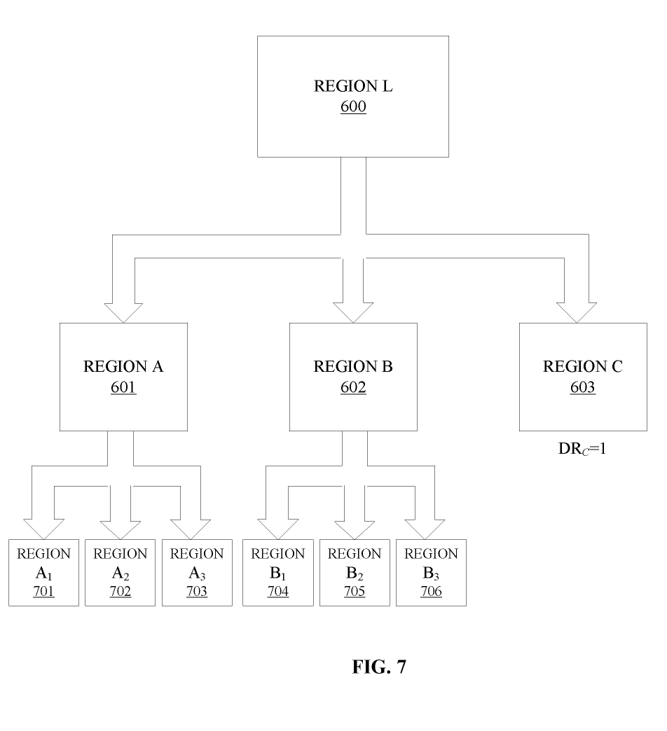

On the other hand, if all the regions resulting from the first iteration are not either concentrated or assigned a corresponding DR value=1, further iterations can be performed. In a next iteration, each of Regions A, B and C may be divided as the original, whole Region L was divided as described above. Thus, referring now to FIG. 7, assuming for example that it was determined that none of Regions A, B and C were concentrated after being allocated ranges DR_{A}, DR_{B} and DR_{C}, Regions A, B and C can each be further divided into three separate regions. As a further example, Region C, say, may have DR_{C}=1. In such a case, Regions A and B would be divided, for instance, into Region A₁ (701), Region A₂, (702), Region A₃ (703), Region B₁ (704), Region B₂ (705), and Region B₃ (706), but Region C would not be further divided.

For each of the newly-formed regions, the corresponding Lmax, Lmin, Lmean and σ of their respective parent population of luminance values can be obtained (i.e., Lmax_{A}, Lmin_{A}, Lmean_{A} and σ_{A}, Lmax_{B}, Lmin_{B}, Lmean_{B} and σ_{B}, and Lmax_{C}, Lmin_{C}, Lmean_{C} and σ_{C}, as needed). Moreover, DR as in (7), (8), (9) can be set to DR_{A}, DR_{B} and DR_{C} correspondingly as obtained from the first iteration. Further, F_{std} for the corresponding region can be increased. For example, in the k^{th} iteration, F_{std} for the corresponding region can be set to k×F_{std}.

Processing can be performed recursively as described above for additional iterations. Processing can be stopped after all regions are either concentrated or have a corresponding DR value=1.

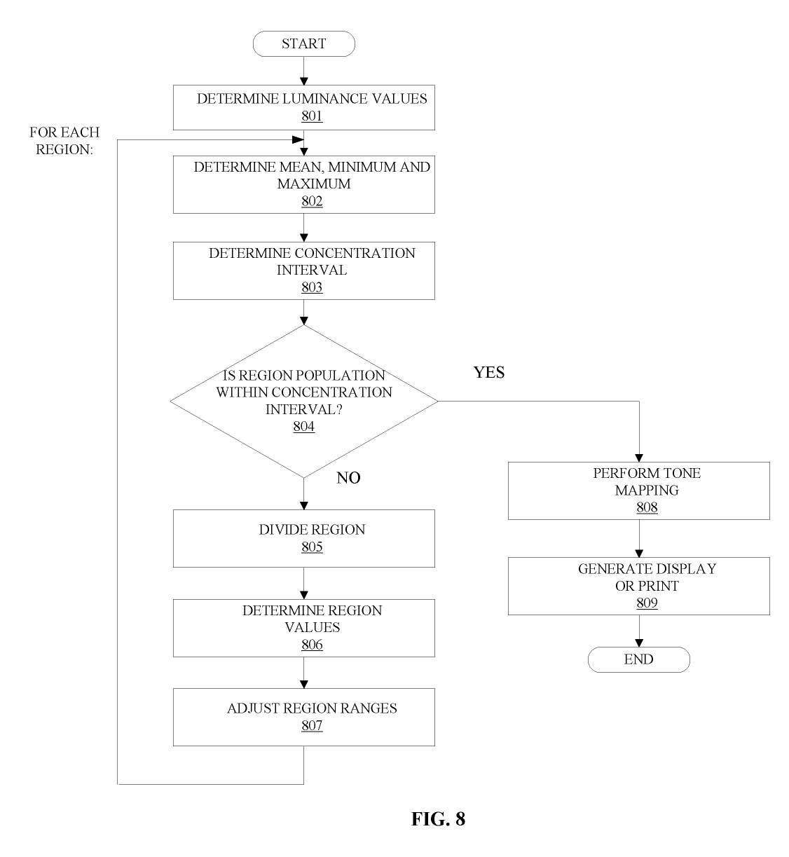

FIG. 8 illustrates a process flow in accordance with the above discussion. As shown in FIG. 8, operations according to embodiments of the invention can include determining luminance values in an input set of image data (block 801). This input set of image data can be viewed as an initial whole or undivided region. The operations can further include determining the mean, minimum and maximum of the luminance values of this region, and for each region of plural regions that is formed from the initial whole region (block 802).

A concentration interval can be determined based on the mean, minimum and maximum (block 803). More specifically, the concentration interval can be defined as the product of a factor F_{std} as described above, and the standard deviation σ_{L} of the luminance values.

The concentration interval can act as a decision criterion or stopping condition as discussed above. Thus, operations can further include determining whether a region containing the population of luminance values is within the concentration interval (block 804).

If not, the region can be divided into plural regions (block 805) and region values can be determined for each of the plural regions (block 806). A region value can depend at least in part on a range of the corresponding region, as discussed above.

The region ranges can be adjusted, based at least in part on the region values, to form regions with adjusted ranges (block 807). A mean, minimum and maximum for each of the regions with the adjusted ranges can be determined (block 802), and a concentration interval can be determined for each of the regions with the adjusted ranges (block 803).

It can then be determined whether the respective populations of luminance values in the regions with the adjusted ranges are within their respective concentration intervals (block 804). If all regions either meet this stopping condition or have been allocated a dynamic range DR=1, tone mapping can be performed for each region (block 808). A display or print of the tone-mapped image can be generated (block 809). Otherwise, blocks 802-807 can be iterated recursively until the stopping condition is met.

### 5. TONE MAPPING

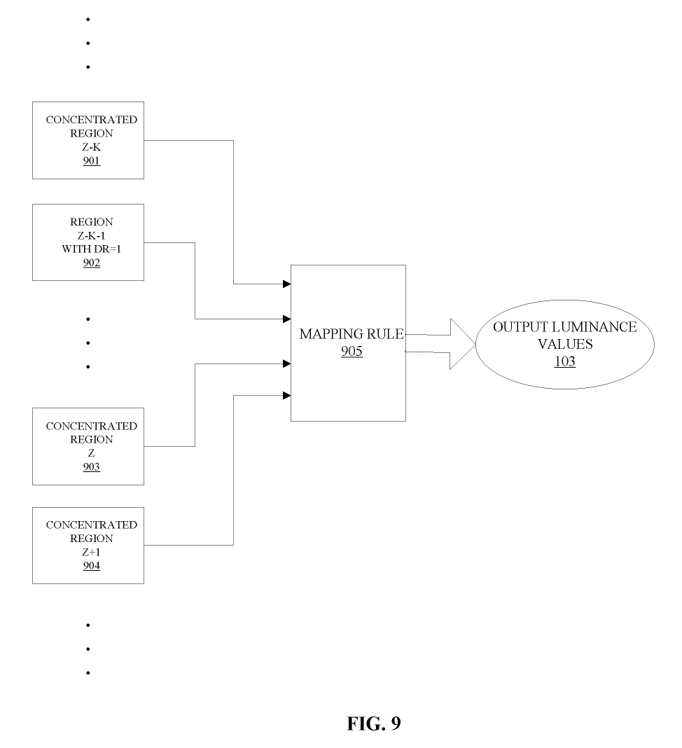

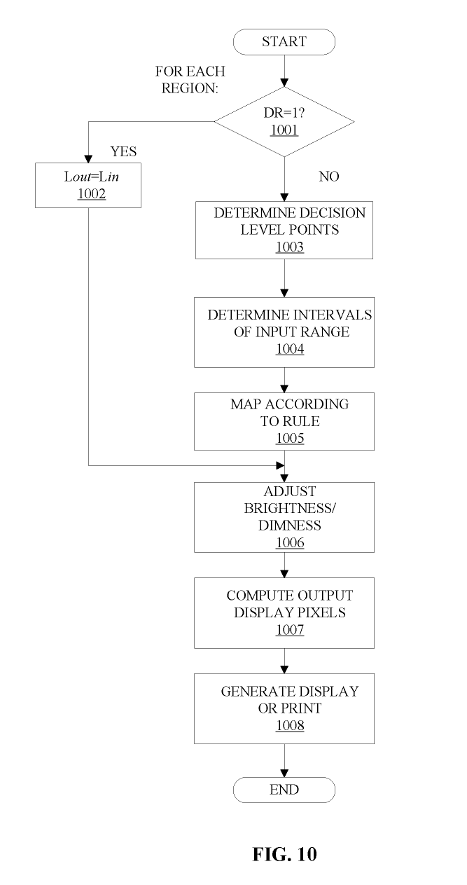

As described above, tone mapping by quantization can be performed for every concentrated region or region with DR=1. This is illustrated in FIGS. 9 and 10 by way of example. Referring now to FIG. 9, assume that after plural iterations several separate regions that are either concentrated or have DR=1 have been formed. For example, a Region Z−K 901 is concentrated, a Region Z−K−1 902 has DR=1, a Region Z 903 is concentrated, a Region Z+1 904 is concentrated, and so on. According to a tone mapping component 102 (see FIG. 1), each of the regions can be processed by a mapping rule 905 to map input luminance values therein to an output set of luminance values 103.

FIG. 10 illustrates a process flow corresponding to an example of application of the mapping rule 905. According the mapping rule 905, if the dynamic range (DR) allocated to a region is 1 (block 1001), then each value inside the region will be mapped directly to that same value (i.e., an output luminance value Lₒᵤₜ=an input luminance value Lᵢₙ) (block 1002).

Now consider an arbitrary concentrated region, denoted for convenience as Region Z 903 (see FIG. 9), allocated range [x, x+y]. In embodiments of the invention, y−1 decision level points can be determined for quantizing the values in range [x, x+y] (block 1003). To determine the decision points, Lmax_{Z}, Lmin_{Z} and Lmean_{Z} can be calculated in order to compute a factor, Fₘₑₐₙ:

$${F}_{mean} = \frac{\begin{matrix}number of values greater than \\ or equal to {Lmean}_{Z}\end{matrix} }{number of values smaller than {Lmean}_{Z}} . \qquad ( 10 )$$

A w^{th} decision level point DP(w) for quantization can be determined by the below expression:

DP(w)=Lmin_{Z}+(w/y)^{F}^{ₘₑₐₙ}×(Lmax_{Z}−Lmin_{Z}) (11)

where w=1, 2, . . . , y−1.

It can then be determined in what intervals values in the input range [x, x+y] lie (block 1004). The input values can then be mapped according to the mapping rule (block 1005). For example, values lying in the first interval [x, x+DP(1)] can be mapped to x, values lying in the second interval [x+DP(1), x+DP(2)] can be mapped to x+1, and so on. F mean controls the quantization performance by adjusting the size of the quantization intervals. When F mean is equal to 1, every interval is of the same size and so the quantization is uniform. F mean may typically be quite close to 1 because the region is concentrated, thus the quantization may be characterized as “uniform-like.”

After the tone reproduction curve is constructed by the above-described quantization, the brightness or dimness of the resulting image can be adjusted (block 1006). More specifically, for example, the 20th percentile of input luminance values can be compared to the 20th percentile of the reproduction range after mapping. If the 20th percentile of input luminance values are not greater than the 20th percentile of the reproduction range after mapping, all decision level points can be exponentially decreased so that the resulting image is not too dim. A similar technique can be applied to the 80th percentile of input luminance values so that the tone-mapped image is not too bright. The above-described adaptive techniques improve the image quality without altering the image characteristics.

After the tone reproduction curve is finalized, the following expression can be used to compute the output display pixels (block 1007):

$${R}_{out} = {( \frac{{R}_{in}}{{L}_{in}} )}^{γ} {L}_{out} , {G}_{out} = {( \frac{{G}_{in}}{{L}_{in}} )}^{γ} {L}_{out} , {B}_{out} = {( \frac{{B}_{in}}{{L}_{in}} )}^{γ} {L}_{out} , \qquad ( 12 )$$

where Lᵢₙ and Lₒᵤₜ are luminance values before and after tone reproduction, respectively, and γ=0.5 controls the display color. A display or print corresponding to the output pixels can be generated (block 1008).

### 6. PERFORMANCE

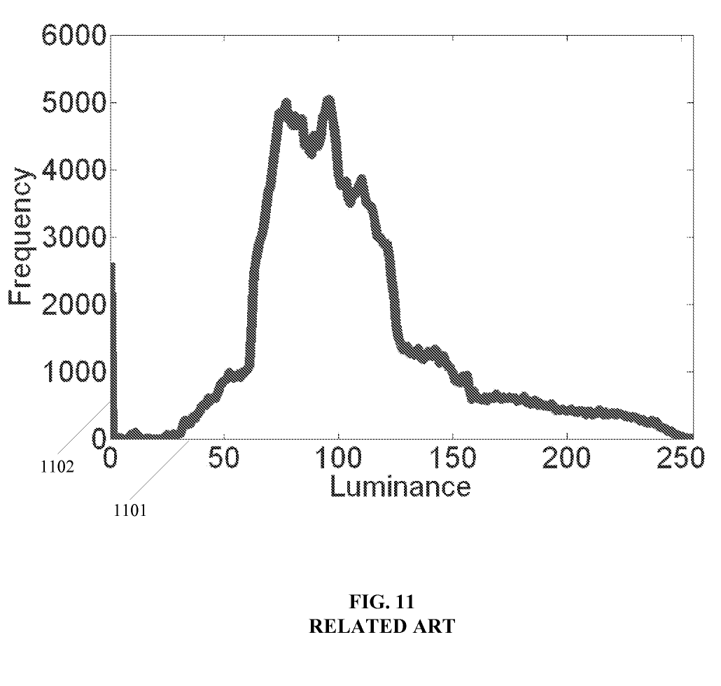

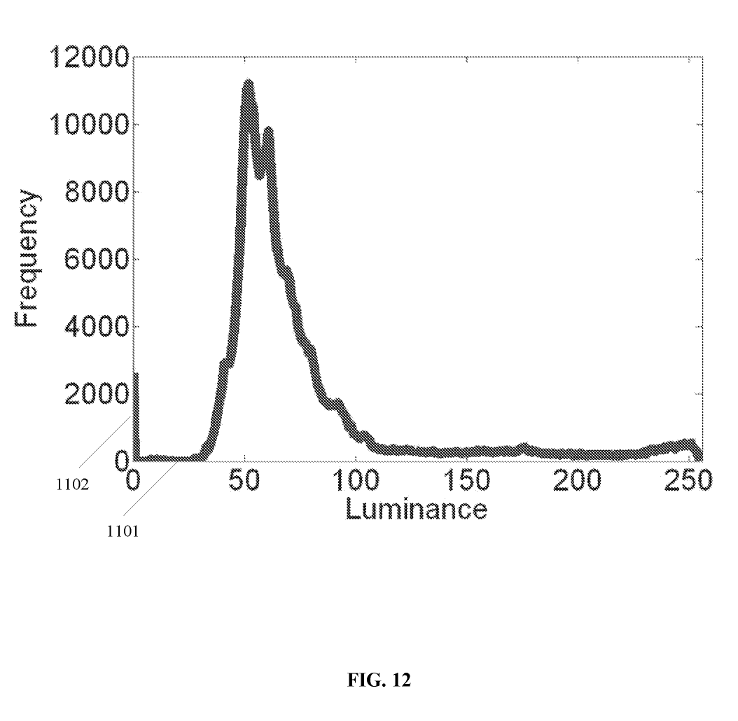

FIGS. 11 and 12 respectively show a result according to related art, versus a result achieved by components according to various non-limiting embodiments of the invention as described herein. FIG. 11 shows a histogram with a luminance axis 1101 and a frequency axis 1102, corresponding to an HDR image tone-mapped to a low dynamic range by a related art technique. Specifically, the histogram of FIG. 11 represents a result using techniques as described in J. Duan and G. Qiu, Fast Tone Mapping for High Dynamic Range Images, ICPR2004, 17th International Conference on Pattern Recognition, Volume 2, pp. 847-850, 2004.

FIG. 12, by contrast, shows a result achieved using components according to embodiments of the present invention. FIG. 12 is a histogram corresponding to the same HDR image as in FIG. 11. The histogram of FIG. 12 is subjectively comparable to that of FIG. 11, but based on the shape of the histograms, it can be seen in FIG. 12 that the image characteristics of the HDR image are preserved, while FIG. 11 shows that the image characteristics have been altered.

### 7. IMAGE PROCESSING SYSTEM

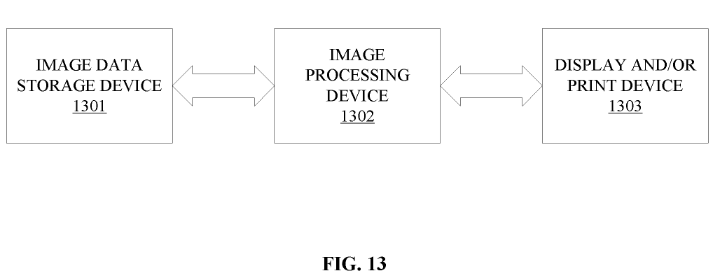

FIG. 13 shows an image processing system 1300 according to embodiments of the invention. The system 1300 can include an image data storage device 1301, an image processing device 1302 and a display and/or print device 1303. The image data storage device 1301 can be any kind of apparatus for storing image data including luminance values, such as a memory card, an optical disk, a hard disk associated with a computer, or the like. The image data stored on the device 1301 can be HDR data.

The image data device 1301 can be coupled to, communicate with, or be otherwise associated with an image processing device 1302. The image processing device 1302 can include logic to process input luminance values obtained from the image data storage device 1301 in accordance with embodiments of the present invention.

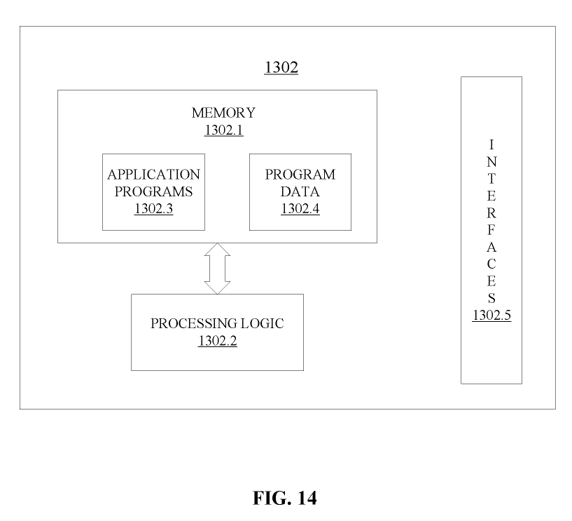

FIG. 14 shows the image processing device 1302 in more detail. The image processing device 1302 can include a memory 1302.1 coupled to, in communication with, or otherwise associated with processing logic 1302.2. The memory 1302.1 can include any kind of medium, such as RAM, ROM, PROM, EPROM, EEPROM, cache, optical disk, hard disk and the like. The memory 1302.1 can, for example, store application programs 1302.3 and program data 1302.4, which can include instructions executable by processing logic 1302.1 for implementing processes according to embodiments of the invention. The memory 1302.1 can further store image data including luminance values for processing according to the embodiments.

The image processing device 1302 can be coupled to, communicate with, or be otherwise associated with the image data storage device 1301 and the display and/or print device 1303 by way of one or more interfaces 1302.5. The image processing device 1302 can obtain image data for processing from the image data storage device 1301 via the one or more interfaces 1302.5, for example. The interfaces 1302.5 can enable the image processing device 1302 to be coupled to, communicate with, or be otherwise associated with additional input/output devices.

Processing logic 1302.2 can include any kind of programmed or programmable logic device, such as a general purpose processor chip or an application-specific integrated circuit (ASIC). To implement processes according to embodiments of the invention, processing logic 1302.2 can execute instructions received from memory 1302.1, for instance, or can execute hard-wired logic or microcode or firmware embedded in application-specific circuits, or any combination thereof.

The image processing device can be coupled to, communicate with, or be otherwise associated with the display and/or print device 1303. After processing by processing logic 1302.2, image data can be displayed or printed on display and/or print device 1303, for example by way of one or more interfaces 1302.5. Display and/or print device 1303 can include any kind of display and/or print device. For example, display and/or print device 1303 can be a liquid crystal display (LCD) on a digital camera, or a monitor or printer associated with a personal or other computer, and the like. In particular, display and/or print device 1303 can be an LDR device, such as an 8-bit device.

The image processing system 1300 can include all or any combination of the image data storage device 1301, image processing device 302 and display and/or print device 303 in a single unit. Alternatively, components 1301, 1302 and 1303 can be separate and distributed across plural units or systems.

For example, one or more components of the image processing system 1300 can be included in a computing device (e.g., a personal computer, a laptop, a handheld computing device, . . . ), a telephone (e.g., a cellular phone, a smart phone, a wireless phone, . . . ), a handheld communication device, a gaming device, a personal digital assistant (PDA), a teleconferencing system, a consumer product, an automobile, a mobile media player (e.g., MP3 player, . . . ), a camera (e.g., still image camera and/or video camera, . . . ), a server, a network node, or the like. However, the claimed subject matter is not limited to the aforementioned examples.

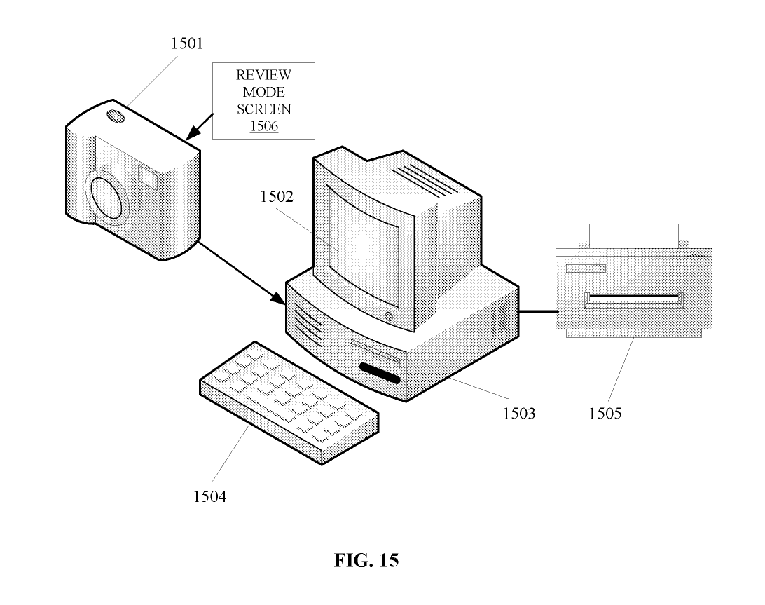

FIG. 15 shows one possible configuration of the image processing system 1300. FIG. 15 shows an image capture device 1501, such as a digital camera, associated with a computer system comprising a display device 1502, central processing unit (CPU) and memory 1503, a user interface such as a keyboard 1504, and a printer 1505. Components of the image processing system 1300 can be distributed in the configuration of FIG. 15. For example, the image capture device 1501 can capture and store image data, such as HDR image data, and transfer it to the CPU and memory 1503. The CPU and memory 1503 can execute processes according to various embodiments of the invention as described above, and display an LDR image corresponding to the HDR image data on the display device 1502, or cause the LDR image data to be printed on the printer 1505.

Alternatively, processing logic can be embodied in circuits of the image capture device 1501 to implement components of the invention. For example, in an embodiment where the image capture device 1501 is a digital camera, the processing logic can process the HDR data and generate a corresponding display on an LDR review mode screen 1506, for example, of the camera 1501.

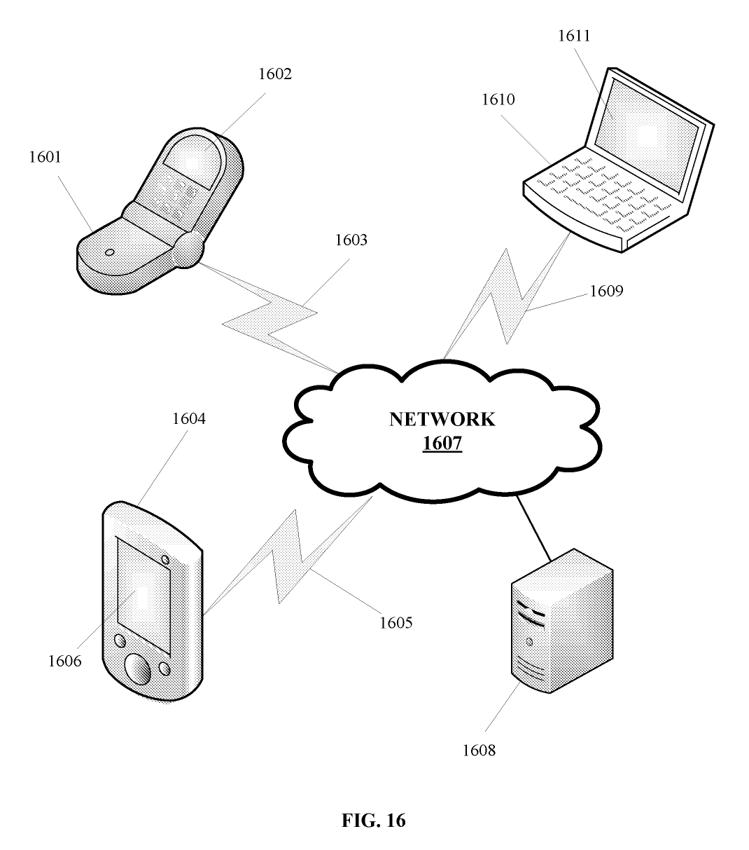

FIG. 16 shows another possible configuration of the image processing system 1300. In FIG. 16, mobile devices 1601, 1604 and 1610 are coupled to a network 1607 via communication links 1603, 1605 and 1609, respectively. For example, mobile device 1601 can be a mobile telephone including a display 1602, which can be an LDR display. Mobile device 1604, for instance, can be a personal digital assistant (PDA) including a display screen 1606, which can be an LDR display. Mobile device 1610, for instance, can be a laptop computer including a display 1611, which can be an LDR display. Network 1607 can include a server 1608.

Components of the image processing system 1300 can be distributed in the configuration of FIG. 16. For example, the server 1608 can store HDR image data and can include logic to execute processes according to various embodiments of the invention as described above to generate LDR data. The network 1607 can transmit the LDR data to the mobile devices 1601, 1604 and 1610 via their respective communication links 1603, 1605 and 1609, for display on their respective displays 1602, 1606 and 1611. Alternatively, processing logic can be embodied in circuits of the mobile devices 1601, 1604 and 1610 to implement components of the invention. The processing logic can process HDR data transmitted by the network 1607 and generate a corresponding display on LDR displays 1602, 1606 and 1611.

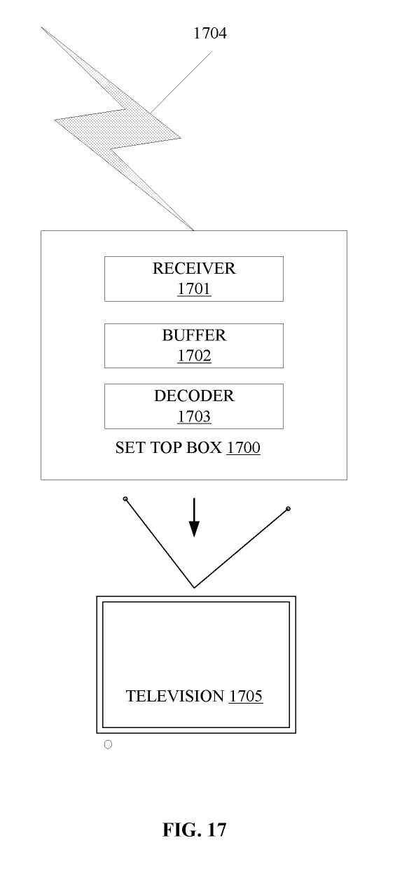

FIG. 17 shows still another possible configuration of the image processing system 1300. In the configuration of FIG. 17, a set-top box 1700 can receive signals from a signal source 1704, which by way of example can be digital broadcast television, cable, telephone, satellite, microwave and the like. A receiver 1701 of the set-top box 1700 can receive the signals and store them in a buffer 1702. A decoder 1703 of the set-top box 1700 can include processing logic to implement components of the invention. The processing logic can process HDR data received from the signal source 1704 and stored in the buffer 1702, and generate a corresponding display on a television 1705.

The subject matter disclosed herein is not limited by the examples given. In addition, any aspect or design described herein as exemplary is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be effected across a plurality of devices. Accordingly, no single embodiment shall be considered limiting, but rather the various embodiments and their equivalents should be construed consistently with the breadth, spirit and scope in accordance with the appended claims.

What is claimed is:

1. A method comprising:
(a) dividing an input set of luminance values into a plurality of regions;
(b) determining characteristics of luminance values in each of the regions;
(c) forming a decision criterion based on (b);
(d) applying the decision criterion to the luminance values in each region; and
(e) if the criterion is met, performing tone mapping of the luminance values in each of the regions.

2. The method of claim 1, where the determining of characteristics includes determining a minimum of the luminance values, a maximum of the luminance values, a mean of the luminance values and a standard deviation of the luminance values.

3. The method of claim 2, wherein the applying of the decision criterion includes determining whether the luminance values are within a range based on the standard deviation.

4. The method of claim 3, wherein the determining whether the luminance values are within the range includes determining whether the luminance values are within a range as a function of the standard deviation multiplied by a factor based on the characteristics.

5. The method of claim 4, wherein the determining whether the luminance values are within the range includes determining whether the luminance values are within a range as a function of the standard deviation multiplied by a factor, F_{std}, based on the characteristics where the factor, F_{std}, is given by
Diffₘₘ=min[(Lmean_{g}−Lmin_{g}),(Lmax_{g}−Lmean_{g})]
F_{std}={square root over (log 10(8+(Lmax_{g}−Lmin_{g})/Diffₘₘ))},
where Lmean_{g}, Lmin_{g}, and Lmax_{g} are the mean, minimum and maximum of the luminance values in a corresponding region.

6. The method of claim 1, further comprising calculating alternative factors F or F_{P2} to calculate a region value Rg_{A} for determining a range allocation for a region, wherein
$${F}_{P 1} = log 10 ( 8 + \frac{L {max}_{L} - L {min}_{L}}{min [ ( {Lmean}_{L} - L {min}_{L} ) , ( L {max}_{L} - L {mean}_{L} ) ]} ) , \\ {F}_{P 2} = 0.5 + {( \frac{{Pmean}_{L}^{′}}{2} )}^{{2}^{k}} , \\ {Rg}_{A} = {P}_{A}^{{F}_{P 1}} \times {R}_{A} ,$$
Lmax_{L} is a maximum of luminance values in a region L, Lmin_{L} is a minimum of the luminance values in the region L, Lmean_{L} is a mean of the luminance values in the region L, k is an iteration number and Pmean_{L} is a probability density greater than the mean in region L, and if Pmean_{L}<0.5, Pmean′_{L}=1−Pmean_{L} and otherwise Pmean′_{L}=Pmean_{L}, and F_{P2} is substituted for F_{P1} if a population of luminance values of region L is at least once within a certain standard deviation.

7. The method of claim 1, further comprising at least one of generating a display of or printing a corresponding tone-mapped image.

8. A machine-readable medium storing computer-executable instructions to implement a method according to claim 1.

9. A method for processing an image, comprising:
(a) determining input luminance values of the image;
(b) determining a mean, a minimum and a maximum of the input luminance values;
(c) determining a first interval based on the mean, the minimum and the maximum of the input luminance values;
(d) determining whether the input luminance values are within the first interval;
(e) if the input luminance values are within the first interval, performing quantization of the input luminance values; and
(f) if the input luminance values are not within the interval, dividing the input luminance values into plural regions.

10. The method of claim 9, further comprising:
(g) determining a region value for each region, the region value based at least in part on a range of the region; and
(h) adjusting the range of a region based at least in part on the region value, to form an adjusted range.

11. The method of claim 10, further comprising:
(i) determining a mean, a minimum and a maximum of input luminance values in the adjusted range;
(j) determining a second interval based on the mean, the minimum and the maximum of the input luminance values in (i);
(k) determining whether the input luminance values are within the second interval;
(l) if the input luminance values are within the second interval, quantizing the input luminance values in the adjusted range.

12. The method of claim 11, wherein for a range [x, x+y], the quantizing includes quantizing with a quantization interval determined by:
$${F}_{mean} = \frac{number of values greater than or equal to Lmean}{number of values smaller than Lmean}$$
$$DP ( w ) = L min + {( w / y )}^{Fmean} x ( L max - L min ) ,$$
where DP(w) is a w^{th} decision level point, Lmin is a minimum input luminance value in the adjusted range, Lmax is a maximum input luminance value in the adjusted range, and Lmean is a mean of the input luminance values in the adjusted range.

13. The method of claim 12, wherein the determining of input luminance values includes determining high dynamic range values, and wherein the quantizing including outputting low dynamic range luminance values.

14. A machine-readable medium storing computer-executable instructions to implement a method according to claim 9.

15. A method comprising:
dividing a set of input luminance values into plurality of regions each having a range;
establishing a stopping condition based at least in part on a standard deviation of luminance values of a region;
recursively adjusting the ranges of the regions until they meet the stopping condition; and
after the regions meet the stopping condition, quantizing the luminance values in each region to form an output set of luminance values.

16. The method of claim 15, wherein the establishing a stopping condition includes defining the stopping condition as being that all luminance values within a region are within a standard deviation of the luminance values in the region, multiplied by a factor.

17. The method of claim 16, wherein the defining the stopping condition includes determining the factor based on at least one of a minimum, maximum or mean of luminance values of a region.

18. The method of claim 16, wherein the quantizing the luminance values in each region to form an output set of luminance values includes quantizing the output set of luminance values as low dynamic range values.

19. A machine-readable medium storing computer-executable instructions to implement a method according to claim 15.

20. An image processing system comprising:
a memory; and
logic coupled to the memory;
wherein the memory is to store input luminance values corresponding to an image; and
wherein the logic is to execute a process including:
dividing a set of input luminance values into plurality of regions each having a range;
establishing a stopping condition based at least in part on a standard deviation of luminance values of a region;
recursively adjusting the ranges of the regions until they meet the stopping condition; and
after the regions meet the stopping condition, quantizing the luminance values in each region to form an output set of luminance values.

21. The image processing system of claim 20, wherein the input luminance values are characterized by a high dynamic range.

22. The image processing system of claim 20, wherein the output luminance values are characterized by a low dynamic range.

23. The image processing system of claim 20, further comprising at least one of an image capture device, a display device or a print device.
